(19) United States
(12) Patent Application Publication
(10) Pub. No.: US 2002/0196567 A1
(43) Pub. Date: Dec. 26, 2002

(54) Single-integration, multiple-refresh mirror system and method

(76) Inventor: James Brannaman, Portland, OR (US)

Correspondence Address: JAMES K. BRANNAMAN, 2853 N. EMERSON CT., PORTLAND, OR, 97217, US

(21) Appl. No.: 10/143,935

(22) Filed: May 14, 2002

Related U.S. Application Data
(60) Provisional application No. 60/290,783, filed on May 15, 2001.

(51) Int. Cl. G02B 5/08

(52) U.S. Cl. 359/883; 359/838; 359/871

(57) ABSTRACT

A system and method for refreshing the optical performance of a reflection system employed in the environment of a food-display case. In the system, and in its performance, outer, thin, flexible-sheet layers become damage-managing, peel-away, sacrificial layers whose serial removal creates optical-reflection refreshment for the system as a whole.

### CROSS-REFERENCE TO RELATED APPLICATION

This application claims priority to Provisional U.S. Patent Application Serial No. 60/290,783 filed on May 15, 2001 for “MultiMirror”, the disclosure in which is hereby incorporated herein by reference.

### BACKGROUND AND SUMMARY OF THE INVENTION

This invention relates to food-display case mirrors, and in particular, to a method and system for protecting, managing and refreshing the reflective optical qualities of such mirrors within their respective “working environments”.

It is well known, and frequently observed, in the food industry that mirrors which are deployed in display cases for fresh produce, meats, and fish, etc., become, in relatively short order, significantly degraded and compromised by attacks which take place against their outwardly facing surfaces. Continuous exposure to moisture and various contaminants that exist within those environments relentlessly work their way in degrading the exposed surfaces of display background mirrors, and it is not very long before what was once a fresh and crisply reflecting mirror no longer produces the desired, appealing, reflection image for customers. The problems associated with such mirror surface degradation are especially amplified by the fact that reflection images are usually the result of double passages of light rays through the exposed mirror surface, each of which passages, where surface damage is in place, plays an appreciable role in reflected image degradation.

The present invention centers its attention on addressing this problem, and does so in a simple, unique, inexpensive and very effective way, proposing and offering several embodiments and practices that furnish different specific solution approaches.

Proposed according to the present invention is a system and a related methodology which involve preparing special reflection structures that are constructed to enable recurrent, serial refreshment of their outer, exposed, viewable surfaces. This is accomplished through a structural arrangement which features a stack layer system of sheets that can be peeled away from one another, one at a time, to expose fresh undersheets, all of which sheets play a roll in refreshing/preserving the desired mirroring performance intended to attract customers to the produce, etc. in display cases. The refreshment-layer approach proposed by the present invention should be carefully distinguished from conventional, pre-first-use, protective layering of other kinds of surfaces. Such conventional layering contemplates immediate removal and throwing away of layer material in order to expose the underlying surface for use. In contrast to this, the stacked, plural layers proposed by the present invention are designed to be full resident participators in the functioning of an integrated reflection structure made in accordance with the invention.

According to a preferred embodiment of the invention, which invention is also referred to herein as a single-integration, multiple-refresh layer system, that system involves a united stack of optically transparent, thin, sheet layers suitably joined to the outwardly facing viewing surface of an otherwise conventional mirror. According to this embodiment of the invention, during normal use, there is always an outer exposed layer which acts as a surrogate, sacrificial, outer surface for the underlying mirror. When this surface becomes degraded to a point that poor performance becomes obvious with respect to the clarity of reflected imagery, the layer which possesses this surface is simply peeled away to expose the next-adjacent underlayer. That next-adjacent underlayer sheet then becomes a new, refreshing, yet-undamaged, sacrificial, surrogate outside surface in the overall system.

The sheets in the proposed stack of transparent sheets, up to even a substantial depth (or number) of sheets, say twelve or fifteen deep, each with a thickness, for example, in the range of about 4-10 mils, offer clarity of imagery from images reflected through them from the associated mirror in the background. Interfacial bonding between transparent layers preferably is accomplished through conventional surface-energy static conditions, or through interfacial bonding by a conventional transparent, tack adhesive, somewhat like that which is used in certain note pads to allow separation of pages without underlying page damage. Such bonding structures are referred to herein as uniting mechanism.

If desired, a food display case can be supplied as an original piece of equipment with a fully integrated reflection system including a background mirror which is prepared and assembled with an integrated stack of transparent sheets according to the invention. The invention can also be implemented as an integrated stack of sheets which are appliable to the outer surface of an already installed background mirror.

The entire integrated stack of sheets, in relation to integration with an otherwise conventional, already installed mirror, can also be deployed, among other possible ways, through a joined perimeter-rigidifying frame structure which is mountable inside a food-display case adjacent the perimeter of the on-board mirror.

Other embodiments of the invention are also disclosed herein. One of these takes the form of a plurality of integrated substacks of sheet components which include, in each substack, a rear, thin, mirrored film layer, such as a reflective Mylar layer, on the reflective side of which there are provided plural transparent overlayers, such as those mentioned above. Plural substacks made up in this fashion can be prepared into a single, composite, integrated stack, and the entire composite integrated stack structure can be attached, as above indicated, adjacent the forwardly facing surface of an otherwise conventional display mirror. Such a composite stack could also be attached to some rigidifying panel or perimeter structure even in the absence of there being any on-board rigid mirror. This embodiment of the invention is one in which the mirrored surfaces, are carried as spaced layers within the overall integrated stack of thin flexible sheets, with no reliance being placed upon an on-board rigid mirror.

Still another embodiment of the invention takes the form of an integrated stack of plural, fully self-contained mirror layers, with no intermediate transparent layers. Such mirror layers are suitably installed either against the face of a on-board rigid mirror in a display case, or in some other fashion within the display case.

These and other objects, advantages, features and characteristics of the present invention will become more fully apparent as the description which now follows is read in conjunction with the accompanying drawings.

### DESCRIPTION OF THE DRAWINGS

FIG. 1 is a simplified, schematic, side cross section of a conventional food-display case employing an otherwise conventional mirror which has been integrated with a stack of sacrificial, transparent layer sheets, according to a preferred embodiment of the present invention.

FIG. 2 is a fragmentary, enlarged detail showing, generally in cross section, the integrated assembly of the mirror and stack of sheets present in the display case of FIG. 1. Dashed lines and a curved arrow in FIG. 2 are employed to illustrate peeling away of a surface layer of transparent material after it has been degraded to a point where it is time for its removal.

FIGS. 3 and 4 are fragmentary, cross-sectional views, somewhat like the view presented in FIG. 2, but here, and in each case, showing two different modifications of the invention.

FIG. 3 shows a modification in which a composite integrated stack is made up of a plurality of thin, peel-away mirror layers, each separated by a plurality of peel-away, transparent layers.

FIG. 4 illustrates an embodiment in which a stack of mirrored layers, without any independent peel-away transparent layers, is present.

FIG. 5 is a view which is employed to describe, generally, interfacial bonding which can take place between sheets or layers in a stack of layers, and between the rear surface of such a stack per se and the surface of a supporting structure, such as a conventional mirror, or some other rigid structure.

FIG. 6 is a photographic image, including a clearly visible horizontal dividing line above which one sees the clarity of reflected imagery in a vegetable display case presented through a mirror equipped as illustrated in FIGS. 1 and 2, and below the horizontal line, the condition of a lower portion of that mirror which has not been covered by the structure of the invention, and which, over a period of time, has degraded to the point that the clarity of reflection can be seen to be significantly compromised (blurred).

### DETAILED DESCRIPTION OF, AND BEST MODE FOR CARRYING OUT, THE INVENTION

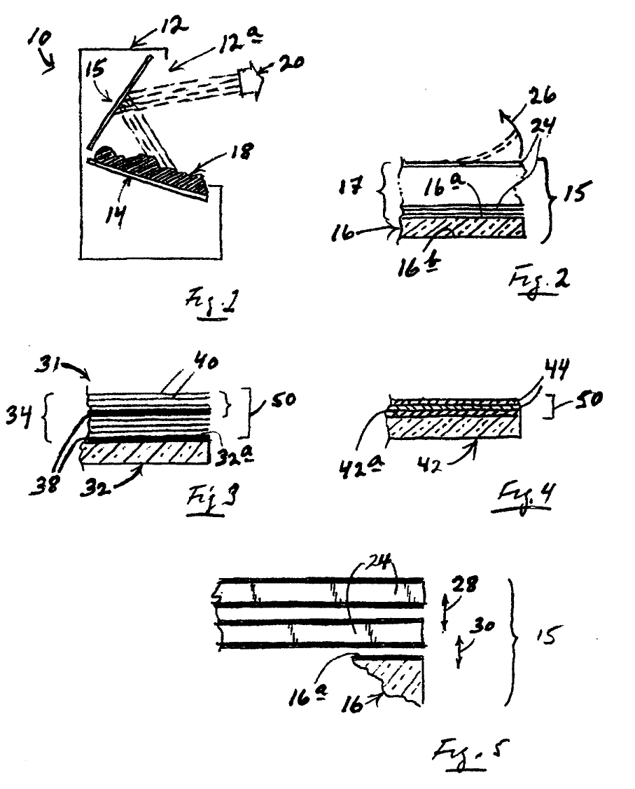

Turning now to the drawings, and referring first of all to FIGS. 1, 2 and 5, indicated generally at 10 in FIG. 1 is a conventional vegetable display case of a type found in most super markets. Display case 10 includes a housing 12, having an open, customer-facing side 12a. Within this housing is a downwardly and forwardly sloped vegetable support platform 14, above which is positioned an angularly disposed, integrated reflection structure 15 including a rigid mirror 16 whose outwardly facing side, or surface, 16a, as will be explained, is covered with a transparent, plural-layer, peel-away stack 17 constructed according to a preferred embodiment of the invention.

A collection of vegetables stored on platform 14 for display in the case is shown generally at 18. The dashed lines in FIG. 1, along with an arrow 20, represent a stored-vegetable reflection from structure 15, with this reflection being directed toward and through opening 12a to the outside region where a customer will stand.

Within the environment of case 12, as is often the case, there is installed a conventional moisture misting system (not illustrated) which is provided both to maintain a high level of humidity in the vicinity of stored vegetables, and also to keep such vegetables looking clean, fresh and inviting to customers. Such a traditional, conventional misting system, when combined with various chemicals and other contaminates that are generally present in the atmosphere, collaborate, unfortunately, but predictably to work progressive damage to, and degradation of, the exposed surface of any reflecting element provided at the location of structure 15. Experience has shown that it does not take very long after the installation of a fresh and new mirror for degradation to show its hand. The lower portion of photographic FIG. 6 illustrates typical results of such degradation, with this degradation taking the form of significant blurring and hazing of the reflected imagery of, stored vegetables.

The relentless attack on the usual display-case reflection system is such that significant degradation is apparent even in a period of time as short as just a few weeks or a month. When that degradation takes place, cleaning of a mirror's surface resolves nothing, inasmuch as the damage has occurred texturally to the mirror's exposed surface itself. This damage causes exaggerated light refraction and scattering, and doubly so at that, because of the fact that a reflected image usually results from light rays that actually pass through the exposed surface of the mirror twice—once on the way in, so-to-speak, and once on the way out.

FIG. 2 illustrates cross-sectional details of integrated structure 15. Included in this structure, as was already mentioned, is a conventional, rigid mirror 16 having forwardly (outwardly) facing surface 16, as well as the usual rear reflective, or mirrored, surface 16b. Applied to surface 16a by static cling (a surface-energy condition) in accordance with the present invention, and to complete the overall, integrated structure of the invention embodiment now being described, is previously mentioned stack 17 containing plural, optically transparent, thin, plastic, flexible sheets, such as the sheets shown at 24. These sheets may be made of any suitable, flexible, clear, plastic, film material, such as a conventional, static-cling vinyl material, with a thickness which may lie preferably in the range of about 4-10 mils. The exact number of such sheets employed in the stack is not critical, and in structure 15, a dozen such sheets (not all illustrated) are employed. These sheets cling to one another, as does the rear-most sheet to mirror surface 16a through static forces. Whichever sheet 24, at any given point in time, constitutes the uppermost, outer, exposed sheet in the stack, acts as a surrogate, sacrificial, forwardly facing viewing surface for structure 15.

With installation of structure 15 into the environment shown in FIG. 1, reflections, as indicated by arrow 20, are initially crisp and clear, and very much like what is shown in the upper portion of photographic FIG. 6. As time wears on, and as the usual, hostile environment within the vicinity of structure 15 (above the displayed produce) works its damaging way on the surface of the then-exposed top sheet of clear transparent material, this layer, when desired, is simply peeled away and removed, as indicated generally by the curled dashed lines, and by curved arrow 26, in FIG. 2. With peeling away of this layer, there occurs, for all practical purposes, a complete refreshment and restoration of the optical reflection qualities of structure 15, and the dimmed, blurred and distorted view which had resulted from degradation of the now-removed top sheet of transparent plastic material—a view which is very much like that pictured in the lower part of FIG. 6—is replaced by a clear and appealing reflection view, such as is illustrated in the upper portion of FIG. 6.

It will thus be apparent that integrated structure 15, as proposed by the present invention, uniquely and very simply solves the problem associated with degradation of mirror surfaces in food-display cases. It does so under circumstances where, with each removal of a transparent sheet after it has been degraded, the effective behavior of the mirroring system is returned to substantially original, pristine operating condition. All of this is done without necessarily requiring any post-installation of new rigid mirror structure within case 12. The change which occurs in reflection clarity after removal of a degraded top layer is quite dramatic, especially in view of the “double-transit” light-ray path often associated with the reflection imagery.

With reference now made to FIG. 5, here there are shown fragments of mirror 16, along with fragments of two of the overlayer transparent sheets 24 which form portions of structure 15. These fragmentary components are shown spaced from one another. The thick, horizontal black lines presented in FIG. 5 represent either (a) surface-energy conditions, such as static cling conditions, or (b) tack adhesive films, chosen for use in the attachments and reuseaible bondings established between the transparent sheets, as well as between the rear-most transparent sheet and the outwardly facing surface 16a of mirror 16. Bonding forces between the sheets themselves, and between the rear-most sheet and mirror surface 16a, are represented by short, double-ended arrows 28, 30 respectively.

Turning attention now to FIG. 3, here, illustrated generally at 31, is a modified form of the invention in which a composite stack is prepared with a conventional, rigid mirror 32, on the upper, outwardly-facing surface 32a in which there is joined a multiple-integrated stack 34, including plural substacks, such as substack 36. Each of substacks 36 includes a rear, thin, flexible, plastic, reflective mirrored layer 38, and stacked on top of this mirrored layer, plural, peel-away transparent sheets, like previously mentioned sheets 24. Such transparent sheets in sub-stack 36 in FIG. 3 are shown at 40.

With the arrangement shown in FIG. 3 assembled in a composite stack with a mirror, such as mirror 32, and installed in a case in the manner illustrated for structure 15 in FIG. 1, as exposed surface degradation reaches a point requiring refreshment, outer transparent sheets 40 are first peeled away serially, and over time, until one of the mirrored layers 38 in the composite integrated substack is directly exposed. When the exposed surface of this then-exposed mirror layer becomes degraded, this layer too is peeled away, and refreshment takes place now via the resulting fresh exposure of a new substack of transparent sheets 40 which overlie another reflective mirror layer 38.

FIG. 4 illustrates yet another embodiment of the invention wherein, suitably joined to the outwardly exposed surface 42a of a rigid mirror 42, is an integrated stack of thin, flexible, plastic, mirrored layers 44. This integrated structure can be installed as is pictured for structure 15 in FIG. 1. With this embodiment of the invention, there is always directly exposed to the viewing customers a mirror surface itself. When an exposed mirror surface in the integrated stack pictured in FIG. 4 has degraded to the point requiring refreshment, its layer is simply peeled away as an overlayer to reveal and expose, for reflection-operation, the immediate next-adjacent underlayer mirrored layer 44.

In both of the embodiments pictured in FIGS. 3 and 4, it is not necessary that there be a conventional rigid mirror present for the creation of the integrated stacks of layers. Rather, and inasmuch as these two embodiments contain mirror surfaces within the stacks of thin, flexible sheets, these arrangements can simply be mounted on any appropriate rigidfying backing (not shown), or indeed can be stabilized by, for example, a suitable perimeter mounting frame which can be appropriately attached within a display case in the position of structure 15 in FIG. 1. In each of FIGS. 3 and 4, such a perimeter frame is shown schematically at 50.

Accordingly, a preferred embodiment, and several alternative embodiments, of the invention have been illustrated and described herein, each of which uniquely and very satisfactorily, effectively and simply, resolves an issue surrounding reflection performances of display mirrors in food-display cases—an environment wherein conventional mirror surfaces are traditionally subjected to significant and rapid environmental damage. The unique methodology of the invention, implemented by the embodiments described above, can be described generally as involving the steps of (a) establishing a layered stack reflection system whose exposed, outwardly facing surface is serially refreshable by progressive and serial peeling away of damaged-surface outer sheets, and (b) periodically, and as desired, peeling away such damaged outer-layer sheets to refresh the optical performance of the system.

Variations and modifications of the invention, not specifically elaborated herein, are recognized to be possible within the understood scope of the invention, and all of these variations and modifications are considered to be encompassed by and within the spirit of the invention

I claim:

1. A system for managing the optical qualities of the outwardly facing surface of a background mirror in a food-display case, thus to manage the effective image-reflection qualities of the mirror as a whole, said system comprising
a layered (overlayer/underlayer) stack of substantially optically transparent flexible sheets each constituting a layer, said stack having front and rear sides, and being constructed for the serial peel-away removal, on a layer-by-layer basis, of each overlayer sheet from the next-adjacent underlayer sheet, and
mechanism operatively associated with said stack, operable to unite said stack with the mirror (a) to form an integrated reflection structure therewith, and (b) in a condition wherein the stack's said rear side closely overlies the mirror's outwardly facing surface.

2. The system of claim 1, wherein said uniting mechanism takes the form of a surface-energy condition operatively interposed the rear side of said stack and the outwardly facing surface in the mirror, which condition exhibits an affinity for joining the stack to the mirror's outwardly facing surface.

3. The system of claim 1, wherein said uniting mechanism takes the form of a tack adhesive which is provided on the rear side of said stack.

4. The system of claim 1, wherein the layers in said stack have a releasable bonding affinity for one another.

5. The system of claim 4, wherein the mentioned bonding affinity is created by surface-energy conditions extant on the opposite faces of the sheet layers in said stack.

6. The system of claim 4, wherein the mentioned bonding affinity is created by tack adhesive disposed between next-adjacent sheet layers in said stack.

7. A single-integration, multiple-refresh, food-display-case mirror system comprising
a layered (overlayer/underlayer) stack of reflective flexible mirror sheets having a front side and rear side, and being constructed for the serial, multiple-refresh, serial peel-away removal, on a layer-by-layer basis, of each overlayer sheet from the next-adjacent underlayer sheet, and
structure operatively associated with said stack, operable to support said stack in a condition within such a food-display case wherein the stack is appropriately deployed to produce, with respect to food articles residing in the case, food-display reflections to an outside party looking into the case.

8. The system of claim 7 which is specifically for employment in a food-display case of the type having a background mirror, and said support structure takes the form of a mechanism for appropriately positioning the stack adjacent the outwardly exposed surface of that mirror.

9. A single-integration, multiple-refresh, food-display-case mirror system comprising
a mirror-underlayer, flexible sheet structure having a viewing surface, and
plural, serial-peel-away, flexible, optically transparent overlayer sheets disposed operatively over said mirror-underlayer structure's said viewing surface, and formed as an integrated stack with the mirror underlayer structure.

10. The system of claim 10, wherein the mentioned integrated stack forms part of a further integrated, composite-stack, multiple-refresh structure, which composite-stack structure also includes at least one other, like, integrated stack.

11. A method for managing optical reflection qualities of a reflection system in a food-display case comprising
establishing a layered-stack-structure reflection system including a currently active, outwardly facing surface from which, through operation of the stack, reflections emanate, and which currently active surface can be peeled away to expose and make current a fresh, underlayer, like-performance, outwardly facing surface, and
periodically peeling away such currently active surface to expose such an underlayer surface.

12. A method for managing the optical qualities of the outwardly facing surface of a background mirror in a food-display case, thus to manage the effective image-reflection qualities of the mirror as a whole, said method comprising,
forming a plural-layer stack of single-layer, serially peel-away-separable, flexible, optically transparent sheets, and
positioning and stabilizing that stack adjacent the outwardly facing surface of such a background mirror.
